(19) United States
(12) Patent Application Publication
(10) Pub. No.: US 2026/0213190 A1
(43) Pub. Date: Jul. 23, 2026

(54) MELT PROCESS FOR THE PREPARATION OF LiFe1-xMnxPO4 COMPOSITIONS

(71) Applicant: IGNIS LITHIUM INC., La Prairie (CA)

(72) Inventors: Steeve ROUSSELOT, Montréal (CA); Mickael DOLLÉ, Bordeaux (FR); Michel GAUTHIER, La Prairie (CA); Pierre SAURIOL, Mississauga (CA)

(21) Appl. No.: 19/140,463

(22) PCT Filed: Jan. 5, 2024
(86) PCT No.: PCT/CA2024/050009

§ 371 Date: Jun. 18, 2025

Related U.S. Application Data
(60) Provisional application No. 63/479,276, filed on Jan. 10, 2023.

(51) Int. Cl. H01M 4/58; C01B 25/45; H01M 4/02

(52) U.S. Cl. CPC H01M 4/5825; C01B 25/45; C01P 2002/50; C01P 2002/72; C01P 2002/88; C01P 2004/03; C01P 2006/40; H01M 2004/021

(57) ABSTRACT

There is provided a melt process for preparing a cathode material of general formula LiFe₁₋ₓMnₓPO₄ in which x varies between 0 and 1. At least one intermediate composition of the process is prepared under air or under non-buffered inert atmosphere. Also, the process comprises at least one correction step for removing any oxidized iron impurities formed.

### CROSS-REFERENCE TO RELATED APPLICATIONS

The present application claims the benefit of U.S. Provisional Patent Application No. 63/479,276 filed on Jan. 10, 2023. The content of this application is incorporated herein in its entirety by reference.

### FIELD OF THE INVENTION

The present invention relates generally to processes for preparing cathode materials for lithium batteries. More specifically, the invention relates to a melt process for preparing an olivine-type cathode material of the LiFe₁₋ₓMnₓPO₄ composition in which x varies from 0 to 1, wherein at least one intermediate composition of the process is prepared under air or under non-buffered inert atmosphere. Also, in the process according to the invention, a correction step for removing oxidized iron impurities formed may be conducted.

### BACKGROUND OF THE INVENTION

Since Goodenough proposed to use Lithium Iron Phosphate (LFP) olivine structures as cathode materials for lithium batteries, several synthesis procedures have been proposed. Solid-state reaction being by far the most developed technology using finely dispersed reactants fired under reductive atmosphere, most of the time in the presence of an organic carbon precursor, to make carbon-coated LFP (C-LFP) in a single step. The technique developed and used first by Phostech Lithium inc. (WO 02/27823 A1) is now used in China for most of their large-scale production of over 800,000 t/y. Since this process rests on solid-state diffusion of ions to form LiFePO₄, multi-valent ions such as PO₄⁻³ and M⁺² or M⁺³ are less mobile and are usually pre-chemically associated as a single reactant, e.g., FePO₄ or FeC₂O₄, to achieve reasonable dwell time in the reactors. This approach has an inherent cost since it is an additional chemical step in the synthesis process. It is also associated with waste by-products.

More recently an alternative process has been proposed and optimized to make LiFePO₄ (LFP), LiFe₁₋ₓMnₓPO₄ (LFMP) where x varies between 0 and 1, or more complex substituted compositions by a melt process in which low-cost commodity or mineral reactants can be used directly for the synthesis, taking advantage of a liquid reactive bath to rapidly combine all the elements (WO 2013/177671A1). Such a development further reduces phosphate cathode manufacturing cost in a market that is cost competitive, since the synthesis can be made from largely available raw chemical containing elements such as Fe, Mn, P, and Li. Another advantage of a melt process operating over 1000° C. is that thermodynamic equilibrium is rapidly achieved allowing reproductible production from batch to batch. For pure LFP compositions, it was possible to define the stability domain of TOK and oxygen partial pressure (pO₂) in which LiFePO₄ can be made while avoiding over-reduction (e.g., Fe₂P) or accidental over-oxidation (e.g., Li₃Fe₂(PO₄)₃, (Nasicon)) (WO 2015/179972A). When those conditions are realized, usually using CO/CO₂ or H₂/H₂O buffer mixtures to control oxygen partial pressure (pO₂) (well known as the Ellingham curves), chemically clean and reproductive materials can be made using approaches that are well established in the steel industry.

With the more recent interest for LFMP cathode associated with a higher discharge voltage and higher energy content, the use of a molten synthesis approach is particularly attractive since the liquid media, with liquid convection and stirring, is effective at rapidly achieving a homogeneous composition such as Mn-rich compositions, e.g., LiFe_{0.3}Mn_{0.7}PO₄.

There is a need for improved processes for preparing LPF and LFMP cathode materials. In particular, there is a need for improved melt processes that are efficient and cost effective.

### SUMMARY OF THE INVENTION

The inventors have designed and conducted a melt process for preparing an olivine-type cathode material of the LiFe₁₋ₓMnₓPO₄ composition in which x varies from 0 to 1. During the process according to the invention, preparation of at least one intermediate composition is conducted under air or under non-buffered inert atmosphere in condition of thermodynamic equilibrium or kinetic stability. Such gas atmospheres are easier to control and use in an industrial context since they are non-toxic, non-explosive, and associated with a low-cost production. The process according to the invention may also comprise a correction step for removing oxidized Fe⁺³ impurities formed. This was surprisingly found to be beneficial to the powder comminution as well as improving the cathode electrochemical activity.

In embodiments of the invention, the process leads to the preparation of a cathode material having an olivine structure of general formula LiFe₁₋ₓMnₓPO₄ in which x varies between 0 and 1. The process comprises melting together reactants comprising a source of lithium, a source of iron, optionally a source of manganese, and a source of phosphate, individually or in combinations thereof, in desired stoichiometric proportions. The sources of iron and manganese are at the +2 oxidation state or an equivalent mixture of metallic +2 and +3 oxidation states. The melting is conducted in a reaction bath held at a temperature between about 800° C. and about 1300° C. Also, the melting is conducted under a non-buffered and non-reducing atmosphere. The atmosphere may comprise air, N₂, Ar, CO₂, or a mixture thereof.

In embodiments of the invention, the process comprises a step of heating reactants, casting, cooling, and solidification of a liquid composition.

In embodiments of the invention, the process comprises a step of comminution of a solid composition as a powder.

In embodiments of the invention, the process comprises a step of thermally reducing any residual oxidized impurities formed such as oxidized iron impurities (Fe⁺³). A reducing gas atmosphere containing H₂ and/or CO may be used in the reduction process. The reduction process may be conducted at a temperature between about 400° C. and about 900° C.

In embodiments of the invention, the process may further comprise a step of coating the LiFe₁₋ₓMnₓPO₄ micronized powder surface with at least one adherent electric conductor to form an electrochemically active lithium-ion reversible cathode material. In embodiments of the invention such electric conductor comprises carbon and C—LiFe₁₋ₓMnₓPO₄ is obtained.

In embodiments of the invention, there is provided a cathode material obtained by the process described herein.

In embodiments of the invention, there is provided a cathode or battery manufacturing plant, which embodies the process according to the invention.

The invention thus provides the following in accordance with aspects thereof:
(1) A melt process for preparing a cathode material of general formula LiFe₁₋ₓMnₓPO₄ in which x varies between 0 and 1, wherein at least one intermediate composition of the process is prepared under air or under non-buffered inert atmosphere.
(2) A melt process for preparing a cathode material of general formula LiFe₁₋ₓMnₓPO₄ in which x varies between 0 and 1, the process comprising melting together reactants comprising a source of lithium, a source of iron, optionally a source of manganese, and a source of phosphate, individually or in combinations thereof, in desired stoichiometric proportions, wherein the sources of iron and manganese are at the +2 oxidation state or an equivalent mixture of metallic and +2 and +3 oxidation states, in a reaction bath held at a temperature comprised between about 800 and about 1300° C., and wherein the melting is conducted under a non-buffered and non-reducing atmosphere.
(3) The melt process according to (1) or (2) above, wherein the atmosphere comprises air, N₂, Ar, CO₂, or a mixture thereof.
(4) A melt process for preparing a cathode material of general formula LiFe₁₋ₓMnₓPO₄ in which x varies between 0 and 1, the process comprising at least one correction step for removing any oxidized iron impurities formed; preferably the at least one correction step comprises reducing back any oxidized Fe⁺³ formed.
(5) The melt process according to any one of (1) to (3) above, wherein at least one correction step is conducted for removing any oxidized iron impurities formed; preferably the at least one correction step comprises reducing back any oxidized Fe⁺³ formed.
(6) The melt process according to (4) or (5) above, wherein the oxidized Fe⁺³ comprises Fe₂O₃ and/or Li₃Fe₂(PO₄)₃.
(7) The melt process according to any one of (4) to (6) above, further comprising melt casting, solidification, and comminution steps, and the at least one correction step is conducted after one or more of the melt casting, solidification, and comminution steps; preferably the at least one correction step is conducted after the melt casting, solidification, and comminution steps.
(8) The process according to (2) or (4) above, wherein an intermediate composition is produced.
(9) The process according to (1) or (8) above, wherein the intermediate composition is an Mn-enriched composition.
(10) The process according to any one of (4) to (7) above, wherein a reducing gas is used in the at least one correction step; preferably the reducing gas is nitrogen containing only small amounts of H₂ and/or CO.
(11) A melt process for preparing a cathode material of general formula LiFe₁₋ₓMnₓPO₄ in which x varies between 0 and 1, the process comprising the steps of: a) melting together, in a reaction bath, reactants comprising a source of lithium, a source of iron, optionally a source of manganese, and at least one source of phosphate, individually or in combinations thereof, in desired stoichiometric proportions, and wherein the source of iron and the source of manganese are each at the +2 oxidation state or an equivalent mixture of metallic and +2 and +3 oxidation states, and wherein the reaction bath is held at a temperature between about 800 and about 1300° C., and wherein the melting is conducted under a non-buffered and non-reducing atmosphere which comprises air, N₂, Ar, CO₂, or a mixture thereof, thereby obtaining a liquid composition; b) heating the liquid composition, followed by casting, cooling, and solidification, thereby obtaining a solid composition; c) comminuting the solid composition, thereby obtaining a powder having micronized particles; and d) subjecting the powder to a thermal reduction with a reducing gas atmosphere comprising H₂ and/or CO at a temperature between about 400° C. and about 900° C., thereby reducing any oxidized iron impurities formed.
(12) The process according to (11) above, further comprising a step e) of coating a surface of the micronized particles with at least one adherent electric conductor; preferably the adherent electric conductor comprises carbon.
(13) The process according to (12) above, wherein the thermal reduction step d) and the coating step e) are conducted simultaneously by pyrolyzing an organic carbon precursor in the presence of the micronized particles to form a conductive carbon-coated cathode material (C—LiFe₁₋ₓMnₓPO₄).
(14) The process according to any one of (1) to (13) above, wherein LiFe₁₋ₓMnₓPO₄ in which x>0.7 is obtained.
(15) The process according to (2) or (11) above, in which the sources of lithium and phosphate are each in stoichiometric excess by less than 5% molar.
(16) The process according to (11) above, wherein the casting, cooling, and solidification at step b) is conducted fast enough to limit crystal growth to less than 10 μm; preferably less than 3 μm.
(17) The process according to (11) above, wherein the casting, cooling, and solidification at step b) is conducted rapidly by melt atomization using a jet of a fluid that is N₂ or water, or by casting techniques used to form amorphous metal.
(18) The process according to (11) above, wherein the particles obtained at the comminution step c) have a D50 between about 200 and about 10 nanometers as obtained by wet milling, the particles being present as secondary agglomerates whose D50 is less than 30 μm and more than 1 μm.
(19) The process according to (12) or (13) above, wherein the carbon-coated cathode material contains an amount of carbon between about 0.5 and about 5 wt %; preferably the carbon-coated cathode material contains an amount of carbon between about 0.8 and about 2 wt %.
(20) The process according to (12) or (13) above, wherein the comminution of step c) is conducted in wet mill using a solvent; preferably the solvent comprises a soluble iron salt that remains at the surface of the particles during the organic carbon precursor pyrolysis.
(21) Cathode material made by the process as defined in any one of (1) to (20) above; preferably the cathode material is a lithium iron phosphate (LFP), a lithium iron manganese phosphate (LFMP), or a lithium manganese phosphate (LMP) cathode material; preferably the cathode material is carbon-coated.
(22) Cathode material made by the process as defined in (12) or (13) above, having and iron-rich surface on which the conductive carbon-coating is grown.
(23) Battery having a cathode comprising a material made by the process as defined in any one of (1) to (20) above.
(24) Cathode or battery manufacturing plant which embodies the process as defined in any one of (1) to (20) above.

Other objects, advantages and features of the present invention will become more apparent upon reading of the following non-restrictive description of specific embodiments thereof, given by way of example only with reference to the accompanying drawings.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

In the appended drawings:

FIG. 1a: LiMnPO₄ synthesis under air in a graphite crucible with cooling under air. Solely the LiMnPO₄ phase and no impurity are observed by XRD.

FIG. 1b: LiMnPO₄ synthesis under air in an alumina crucible with cooling under air. LiMnPO₄ phase and AlPO₄ impurity related to the crucible are observed by XRD.

FIG. 1c: LiFePO₄ synthesis under air in an alumina crucible with cooling under Ar. Li₃Fe₂(PO₄)₃ and Fe₂O₃ as main phases. An average amount of LFP phase is observed. AlPO₄ phase is coming from the crucible contamination.

FIG. 1d: LiFePO₄ synthesis under N₂ in a graphite crucible with cooling under air. LFP phase is observed with traces of Fe₂O₃.

FIG. 1e: LiFePO₄ synthesis under N₂ in an alumina crucible with cooling under N₂. LFP is the major phase some AlPO₄ impurity observed from the crucible contamination, Li₄P₂O₇ (with possibly Fe₂O₃ or Al₂O₃ based on peaks at 40.5 and) 41°.

FIG. 2a: TGA curves for different Mn-containing LiFe₁₋ₓMnₓPO₄ samples exposed to air.

FIG. 2b: TGA curves under N₂ for different Mn-containing LiFe₁₋ₓMnₓPO₄ samples.

FIG. 3a: Synthesis of LiFe_{0.5}Mn_{0.5}PO₄ from LiPO₃+MnCO₃+FeC₂O₄ precursors under N₂ in a graphite crucible followed by cooling under N₂. Solely the LiFe_{0.5}Mn_{0.5}PO₄ phase and no impurity are observed by XRD.

FIG. 3b: Synthesis of LiFe_{0.5}Mn_{0.5}PO₄ from LiPO₃+MnO₂+Fe⁰ precursors under N₂ in a graphite crucible followed by cooling under N₂. Solely the LiFe_{0.5}Mn_{0.5}PO₄ phase and no impurity are observed by XRD.

FIG. 3c: Synthesis of LiFe_{0.5}Mn_{0.5}PO₄ from LiPO₃+MnO₂+Fe⁰ precursors under N₂ in an alumina crucible followed by cooling under N₂. Solely the LiFe_{0.5}Mn_{0.5}PO₄ and AlPO₄ and Li₃PO₄ phases are observed by XRD.

FIG. 4a: Synthesis of Mn-Rich (75%) using LiPO₃+MnCO₃+FeC₂O₄ precursors in a graphite crucible under air followed by cooling under air. Solely Li Fe_{0.25}Mn_{0.75}PO₄ olivine phase is observed by XRD.

FIG. 4b: Synthesis using LiPO₃+MnCO₃+FeC₂O₄ precursors in an alumina crucible under air followed by cooling under Ar. LiFe_{0.25}Mn_{0.75}PO₄ olivine phase is observed by XRD with Fe₂O₃ and Li₃Fe₂(PO₄)₃ impurities.

FIG. 5a: Correction of an oxidized LFMP composition by a reducing atmosphere gas treatment with 5% H₂/Ar at 800° C.

FIG. 5b: Correction of an oxidized LFMP composition by a reducing atmosphere gas treatment during pyrolysis of an organic carbon precursor in N₂ at 700° C.

FIG. 6a: Pattern of the powder after melt synthesis and after milling and pyrolysis from Example 6a.

FIG. 6b: Pattern of the powder after melt synthesis and after milling and pyrolysis.

FIG. 6c: Electrochemical galvanostatic curve of the powder synthesized in Example 6b.

FIG. 6d: SEM pictures of rapidly cooled LiFe_{0.25}Mn_{0.75}PO₄ sample produced according to Example 6b. 1-2 μm-range crystals of Fe₂O₃ (white shiny crystals) and Li₃Fe₂(PO₄)₃ (grey crystals) embedded in a Mn-rich LFMP matrix (dark background) are visible.

### DESCRIPTION OF ILLUSTRATIVE EMBODIMENTS

Before the present invention is further described, it is to be understood that the invention is not limited to the particular embodiments described below, as variations of these embodiments may be made and still fall within the scope of the appended claims. It is also to be understood that the terminology employed is for the purpose of describing particular embodiments; and is not intended to be limiting. Instead, the scope of the present invention will be established by the appended claims.

In order to provide a clear and consistent understanding of the terms used in the present specification, a number of definitions are provided below. Moreover, unless defined otherwise, all technical and scientific terms as used herein have the same meaning as commonly understood to one of ordinary skill in the art to which this disclosure pertains.

Use of the word “a” or “an” when used in conjunction with the term “comprising” in the claims and/or the specification may mean “one”, but it is also consistent with the meaning of “one or more”, “at least one”, and “one or more than one”. Similarly, the word “another” may mean at least a second or more.

As used in this specification and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process steps.

In the present invention, we have observed that pure LiMnPO₄ (LMP) can be made under air by opposition to LiFePO₄ (LFP) that requires relatively low oxygen partial pressure (pO₂) domain over the melt and during solidification. More important to the present invention, it was discovered that Mn-rich intermediate compositions between LiFePO₄ and LiMnPO₄ can be synthetized under air or alternatively under non-buffered inert atmosphere such as nitrogen or argon and adapted for use as cathode materials. These atmospheres are more attractive for an industrial operation, since made of non-toxic (vs. CO) or non-explosive (vs. H₂) gases giving more flexibility for a manufacturing operation. These non-reducing, non-buffered gases can be used for all or most synthesis steps, such as melting and cooling.

Another feature of the present invention is based on the discovery that lithium iron manganese phosphate (LFMP) compositions, especially Mn-rich LFMP compositions, can be made according to the present invention because Mn-rich compositions can be thermodynamically or kinetically stable at higher pO₂ than what was found with pure LFP, but also because such Mn-rich compositions can be synthetized and corrected later on in the process (after casting, solidification, and comminution) whenever small amounts of oxidized iron contaminants are formed during the process. In the conditions of the present invention, these minor oxidized iron contaminants can be eliminated during a second thermal step used after comminution in which a reducing gas mixture is used such as nitrogen containing only a few percent H₂ or CO. Furthermore, such a correction step can advantageously be realized when an organic carbon precursor is pyrolyzed under reductive condition to carbon-coat the LFMP to insure electronic conduction as per U.S. Pat. No. 6,873,255 B2.

Since in the process of the invention it was shown that when only minute amounts of oxidized Fe⁺³ contaminants such as Fe₂O₃ or Li₃Fe₂(PO₄)₃ are present, while the Mn⁺² remains with the olivine structure only a small amount of the organic precursor used is consumed for reduction of these impurities making it still possible to control the quantity of carbon-coating in the range of 1% through the amount of initial organic carbon precursor used. This is possible with the present invention especially for the Mn-rich LFMP that are not or less sensitive to oxidation when melt-synthesized in a non-buffered and non-reductive atmosphere. A further improvement to this carbon-coating step on Mn-rich composition is to add an iron salt during the wet grinding operation in order to favor higher yield of conductive carbon-coating due to better catalytic activity of iron vs Mn.

The invention rests on a melt process to make a variety of cathode compositions having the olivine structure that can be used to obtain a wide range of compositions characterized by an olivine structure and generally described as:

$${LiFe}_{1 - x} M {n}_{x} P {O}_{4} in which x varies between 0 and 1.$$

It is a specificity of the melt synthesis to enable slight deviations from pure stoichiometry even after solidification. For example, substitution elements can be observed in certain conditions after solidification, such elements are for example Mg, Ca, Ni, Co, Al, Zn, and Si, when they are present in the melt during the synthesis. The formula encompasses these composition deviations as long as the useful structure remains olivine and the electrochemical capacity to exchange lithium ions is not significantly reduced, e.g., less than 20 mAh/g vs. the theoretical capacity of 170 mAh/g.

For the same reasons, compositions having a slight excess of lithium, for example less than 5% molar, usually introduced as LiPO₃ or a mixture of LiPO₃ and Li₃PO₄, are sometimes used and are part of the melt process. And the material obtained contains LiPO₃, Li₄P₂O₇ or Li₃PO₄, or a combination thereof.

The present invention aims preferably at Mn-rich compositions that are known to being not or less sensitive to air exposure during the melt and cooling steps of the melt process, thus avoiding the use of explosive hydrogen or toxic carbon oxide atmospheres.

The synthesis of LiFePO₄ (LFP) cathode material is usually made from Fe⁺² reactants or from Fe⁺³ such as Fe₂O₃ or Fe₃O₄ in combination with a reducing agent in the melt such as Fe⁰; alternatively carbon present in sufficient amount. In both cases, reductive conditions are necessary to maintain or obtain Fe⁺² and the LiFePO₄ olivine since Fe⁺² is rapidly converted to Fe⁺³ in the presence of oxygen at high temperature.

With the melt synthesis of LiFePO₄ the optimal conditions (T and pO₂) to obtain pure LiFePO₄ while avoiding iron over-reduction or over-oxidation have been described in a previous patent application, WO 2015/179972A.

Since the observation that well defined LiMnPO₄ equivalent can be melt-synthesized directly under air, it was discovered that Mn-rich, LiFe₁₋ₓMnₓPO₄ in which x varies between 0 and 1, preferably between 0.5 to 1, and more preferably between 0.7 and 1, can be synthesized in certain simplified conditions while avoiding over oxidized or over reduced impurities making the melt process an attractive one for industrial production where cost and quality are essential.

The simplifications, made possible by the invention, concern the nature of the gaseous atmosphere used during the thermal steps of the synthesis: heat up, melting, solidification, and cooling. During those steps the gaseous atmosphere does not need to be reducing or buffered mixtures of gases to preserve the M⁺² oxidation state of the transition metals in the formed olivine structure. Simple nitrogen or even air can then be used for Mn-rich compositions. Furthermore, with the present invention, only a reducing agent, preferably Fe⁰, needs to be present in the melt in stoichiometric amount to bring all Fe and Mn reactants to the M⁺² oxidation state. There is no need to rely on the atmosphere to fix or control the transition metals oxidation state, allowing more rapid reaction equilibrium in the melt. Finally, a wider range of air compatible crucible materials other than graphite become available to contain and stir the melt itself such as common oxides, nitrides, carbides, phosphate-based ceramics in addition to refractory metals.

Although several Fe- and Mn-bearing reactants or mixture of different composition and oxidation levels can be used with the present invention, the partial use of Fe⁰ as a reducing agent is preferred because of its low cost and ability to rapidly reduce any M⁺³ reactants such as Fe₂O₃ or Fe₃O₄, as well as Mn₂O₃ or MnO₂, to the desired M⁺² oxidation state. However, Mn⁺² compounds such as MnCO₃ or MnO are less sensitive to oxidation and can be used as such.

Carbon could also be used as a reducing agent in the melt to achieve the M⁺² oxidation state, however it will result in the formation CO (and CO₂) that may present toxicity issues in the vicinity of the process furnace. This toxic exposure can be avoided in the present invention by using Fe⁰ as reducing agent.

A convenient global representation of the synthesis is summarized as:

$${LiPO}_{3} + MO == \text{>} {LiMPO}_{4} \qquad Eq . 1$$

In which LiPO₃ and the metal oxide (MO) can result from many chemical combinations and chemical reactants including LiOH, Li₂CO₃, and Li₃PO₄ and Fe and Mn sources of any oxidation state from 0 to +4 as long as electrochemically active M⁺² is formed at the melt temperature.

Another benefit of the present invention is that the process does not require any strongly reducing conditions. Indeed, graphite is favoured as crucible for LFP synthesis since both chemically compatible and optionally reducing, also it can be more easily replaced by other materials such as: refractory ceramics for example oxides like Al₂O₃, MgO, CaO, SiO₂-based, or stabilized zirconia, phosphates, or even metal ones depending on the heating means.

In embodiments of the invention, melt cooling and solidification can usually be done like the synthesis itself under air, N₂, or Argon, optionally in combination with small amounts of reducing gas such as H₂ or CO to avoid explosivity or toxicity, and by batches casting, on a semi continuous or continuous basis.

However, since the melt synthesis in the condition of the present invention, especially the Mn-rich LiFe₁₋ₓMnₓPO₄ compositions which might result in some iron oxidation to Fe₂O₃ and Li₃Fe₂(PO₄)₃ it is sometime preferable to cast, cool, and solidify the melt rapidly in order to limit crystal growth and long-distance phase separation between for example, the remaining Mn-rich olivine phase and other separate phases such as Fe₂O₃ and Li₃Fe₂(PO₄)₃. Small crystalline solids are favorable for the following steps of comminution and avoid the formation of large particles of inhomogeneous chemical composition that are not olivine and may not revert back easily to olivine at a later reductive step of the process. Ideally small crystal growth of less than a few microns are preferred.

Rapid casting technology exists in the industry for amorphous metals and alternatively direct melt atomization with nitrogen or even water is also possible and in common practice of the steel industry for slag and metal to limit crystal growth and weaken the crystal structure for easier comminution. Accordingly, casting, cooling, and solidification are conducted fast enough to limit crystal growth to a few microns such as to avoid large scale phase separation between olivine phase and impurity phases during solidification that would lead to large particles of different chemical nature after comminution but also to facilitate comminution.

In all cases, comminution to submicron and nano dimensions is obtained in several steps by standard means including wet milling and spray drying or equivalent to form secondary agglomerate of <20 μm and >1 μm made up of elementary particles having a D50 of less than 200 nanometers, preferably less than 50 nanometers and even less than 20 nanometers.

In accordance with the present invention LiFeMnPO₄ melt compositions can be treated as thermodynamically or kinetically stable in the presence of oxygen, especially when Mn-rich, thus allowing to synthesize non-oxidized or slightly oxidized melt compositions that will result in essentially an olivine structure after casting and solidification. Furthermore, especially for less-rich Mn composition, another benefit of the invention is to allow to correct minor remaining traces of oxidized impurities in the reactive melt, especially Fe⁺³, after casting and comminution, in a following purification step that is part of the process of the invention. Such step consisting in a heat treatment of the partially oxidized LiFe₁₋ₓMnₓPO₄ powder under a reducing atmosphere such as H₂/N₂ at a temperature low enough to avoid powder sintering, 400-900° C., preferably 600-800° C. However, a preferred mode of realization of this purification step is to combine this reduction step with the step of carbon-coating the powder of the invention by pyrolyzing an organic carbon precursor, preferably in a nitrogen atmosphere, to carbon-coat LiFe₁₋ₓMnₓPO₄ and induce electronic conductivity and optimal electrochemical capacity. It was surprisingly found that this pyrolysis step succeeds to eliminate remaining traces of oxidized impurities as long as they remain intimately close together and revert these back to LiFe₁₋ₓMnₓPO₄. Since with Mn-rich melt compositions only minute amounts of oxidized impurities, generally Fe₂O₃ and Li₃Fe₂(PO₄)₃, are formed it still remains possible to control, from the amount of precursor used, the level of conductive carbon formed during the pyrolysis to optimal C to LiFe₁₋ₓMnₓPO₄ ratio of 0.5 to 5%, preferably 0.8 to 2.5%.

Other surprising benefits of the oxidation-reduction two-steps melt synthesis of LiFe₁₋ₓMnₓPO₄ compositions have been observed as to the ease of comminution steps as well as to better cathode electrochemical performances associated with Fe⁺² oxidation to Fe⁺³ in the melt before solidification especially when rapid cooling is used before comminution and thermal reduction to revert back to LiFe₁₋ₓMnₓPO₄ olivine. Although not limitative as an explanation it is probably linked with the microcrystalline composite phases formed upon rapid solidification (Mn⁺²-rich olivine phase and Fe⁺³ phases (Fe₂O₃ and Li₃Fe₂(PO₄)₃) that may induce mechanical stress and different catalytic property as to C pyrolysis before reverting back to the homogeneous LiFe₁₋ₓMnₓPO₄ olivine structure upon the thermal reductive step.

Since partially graphitized carbon is sometimes more difficult to obtain on Mn-rich LiFe₁₋ₓMnₓPO₄ particles for which x varies between 0 and 1, it is also an additional particularity of this two-steps melt process (melt synthesis and carbon-coating) of the invention to enrich the surface of the Mn-rich LiFe₁₋ₓMnₓPO₄ particle surface of the invention with iron before pyrolysis, preferably as LiFePO₄ or a LiFePO₄ precursor, that is catalytically more efficient at forming partially graphitized carbon. One preferred mode of realisation of this variant of the invention is to introduce in the solvent media used during comminution a small amount of at least a soluble iron-bearing salt simultaneously with the organic carbon precursor. During spray drying for example, both the organic precursor and iron salt are left at the surface of the elementary particles and pyrolyzed as such in order to carbon-coat the Mn-rich LiFe₁₋ₓMnₓPO₄ particles. When salt, such as iron oxalate or nitrates, are decomposed during the pyrolysis and they form FeO at the surface. Iron compound being better catalyst for conductive carbon formation than Mn compounds. In addition, FeO may react with any excess of LiPO₃ that can be adjusted during the melt synthesis, to form surface pure LiFePO₄, according to Eq. 1, resulting in a peripheral composition more favorable to induce a conductive graphitized carbon-coating. Usually in the melt process of the invention an excess of LiPO₃ with the LiFe₁₋ₓMnₓPO₄ melt composition is present to favor making this LiFePO₄ surface enrichment possible.

Although at the present state of the technology higher voltage cathode phosphate with the olivine structure other that the present LiFe₁₋ₓMnₓPO₄ compositions such as LiCoPO₄ and LiNiPO₄ or mixtures thereof are difficult to use with currently available liquid electrolyte compositions optimized for graphite-based lithium-ion batteries, the principle involved for the melt process of the present invention can be used to prepare such higher voltage cathode compositions as confirmed by XRD characterization.

Examples of different compositions and simplified conditions for the synthesis are described in order to illustrate different, non-limiting, mode of realization of the invention although variants are possible that still encompass the key elements of the present invention.

### EXAMPLES

### Example 1: LMP Vs. LFP Behavior Under Air

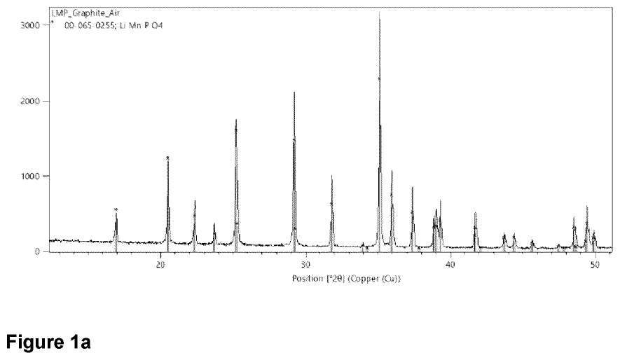

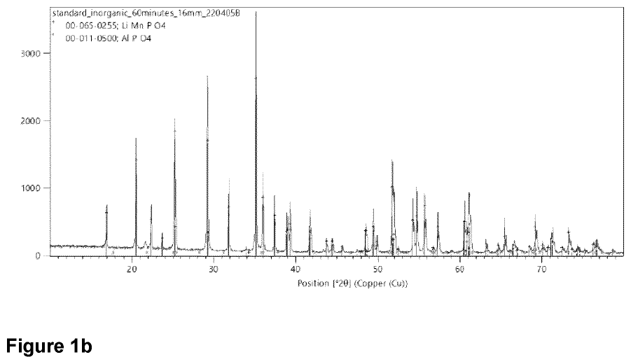

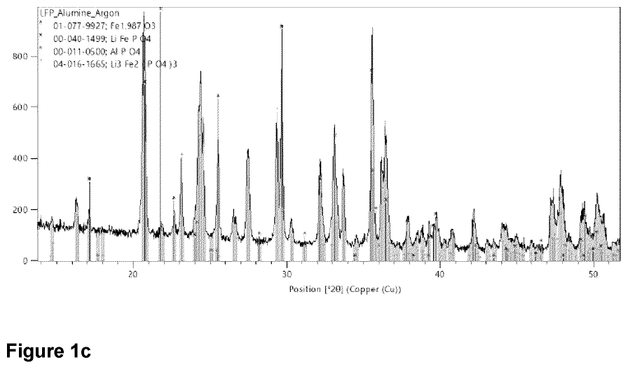

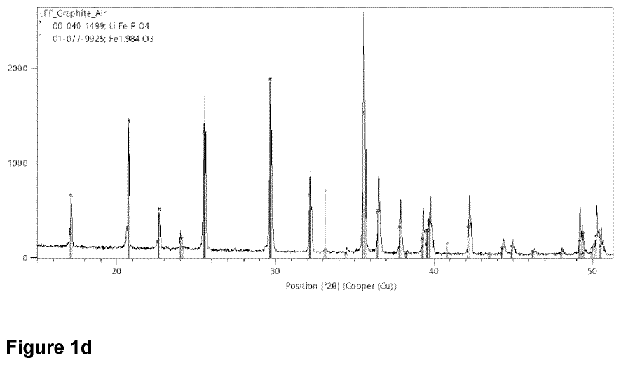

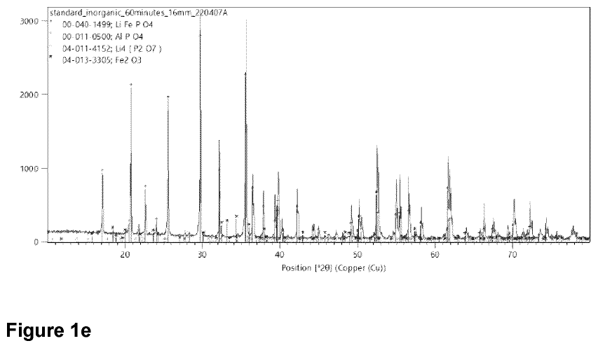

In this example, different tests are conducted to illustrate the contrasting behavior of LiMnPO₄ (LMP) and LiFePO₄ (LFP) during their melt synthesis under different conditions. In Example 1a, LiMnPO₄ is obtained from a mixture of MnCO₃ and LiPO₃ powders in stoichiometric amounts and held for 60 minutes under air at 1100° C. in an open graphite crucible placed in an open furnace followed by cooling under nitrogen. The XRD patterns of FIG. 1a confirm that pure LiMnPO₄ olivine phase is formed. In Example 1b, the experiment is repeated, but using an alumina crucible to avoid any reducing contributions by the graphite or in-situ formed CO/CO₂. In this case pure LiMnPO₄ is also obtained except for a small AlPO₄ phase related to the crucible's slight dissolution as shown in the XRD of FIG. 1b.

By comparison, when the analogous tests are performed under air using FeC₂O₄ and LiPO₃ to synthesize LiFePO₄, Example 1c, the XRDs confirm that most of the product is massively oxidized to Fe₂O₃ and Li₃Fe₂(PO₄)₃ and only a small amount exists as LFP, as shown in FIG. 1c for the alumina crucible.

However, when LiFePO₄ synthesis is performed under N₂ in a graphite or an alumina crucible, partial oxidation can be observed in the XRD as shown in FIG. 1d and FIG. 1e. However, under non-buffered N₂ atmosphere, oxidized impurities are not systematically observed from test to test depending on kinetic and air availability. From these comparative tests, one can conclude that pure LiMnPO₄ olivine can be melt-synthetized under air as opposed to pure LiFePO₄ that ends up massively oxidized under similar conditions. For LFP or Fe-rich LiFe₁₋ₓMnₓPO₄ synthesis under non-buffered N₂ atmosphere, an uncertainty remains as to the possibility of occasional and partial oxidation of the melt with traces of iron oxidation in the final product. An occurrence that can be corrected later-on in the process after casting, solidification, and comminution by a proper treatment of the powder by a reducing thermal treatment preferably during the carbon coating step as will be shown in the following example.

### Example 2: Behavior of Different Mn-Containing LiFe₁₋ₓMnₓPO₄ with the Atmosphere and Reversibility of the Oxidation

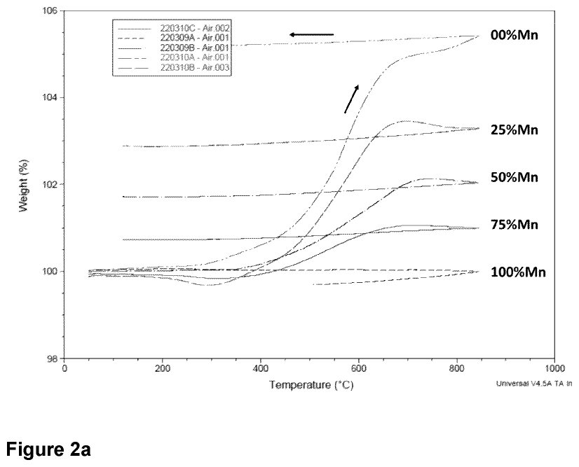

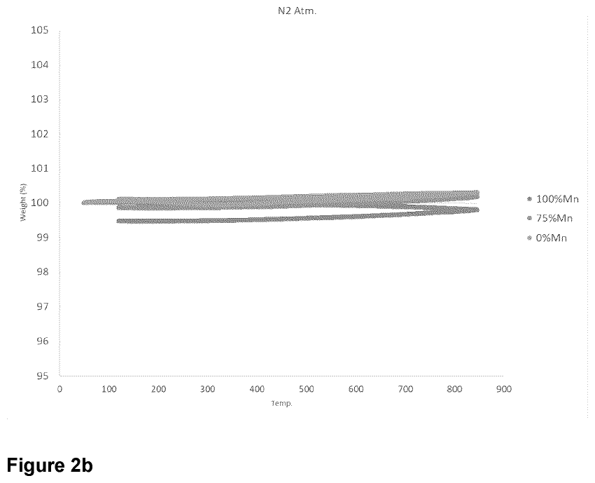

To help illustrate the condition of utilization of the present invention, different LiFe₁₋ₓMnₓPO₄ compositions are heated-up under air and non-buffered N₂ atmosphere, illustrated in FIG. 2a and FIG. 2b, respectively. Under air exposure, the weight gain of Mn-rich composition is small or inexistant while under non-buffered nitrogen atmosphere no significant weigh gain is observed. Weight gain under air appears to be related to the iron content and to the oxidized Fe⁺³ phases observed in Example 1. These observations confirm the interest of the invention since non-buffered nitrogen atmosphere is a low cost and non-toxic one to use for the synthesis of Mn-rich compositions. Based on such test conclusion, it is found possible to use such atmospheres for the melt synthesis of Mn-rich compositions with the capability to heat-up, cast, solidify, and cool-down under similar atmospheres.

Furthermore, based on these observations, even if some minor accidental iron oxidation occurs during the melt synthesis with the partial formation of Fe₂O₃ and Li₃Fe₂(PO₄)₃ observed under such conditions, the melt composition will remain homogeneous if rapidly cast from the melt and solidified to avoid large-scale growth of solid phases of different composition. In such conditions, after comminution, the resulting elementary particle global chemical composition remains homogeneous and can be corrected and reverted back to pure homogeneous olivine of the LiFe₁₋ₓMnₓPO₄ composition by a simple reductive gas treatment, for example H₂/N₂, of the partially oxidized powder, at 600-800° C. If solidification is slow and large crystallites of different nature are allowed to form, comminution will result in particles of different chemical nature that may not easily revert back to the desired olivine LiFe₁₋ₓMnₓPO₄ phase upon reduction. A preferred approach is to make the reduction during the organic carbon precursor pyrolysis at 450-750° C. during the carbon coating step that inherently generates such a reducing atmosphere. XRD measurements confirm the reversibility of the oxidized Fe₂O₃ and Li₃Fe₂(PO₄)₃ back to the original desired olivine LiFe₁₋ₓMnₓPO₄ composition.

### Example 3: 50% Mn LFMP Composition Synthesis Under Inert and Non-Buffered N₂ Atmosphere and Under Air

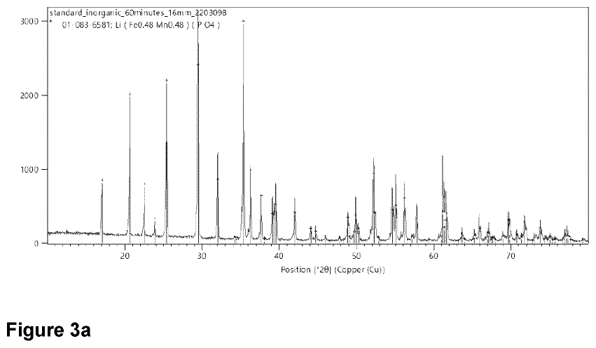

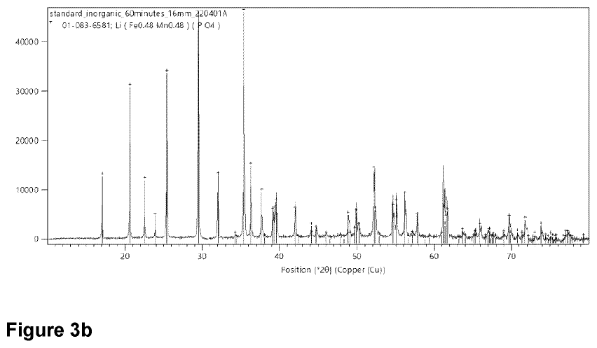

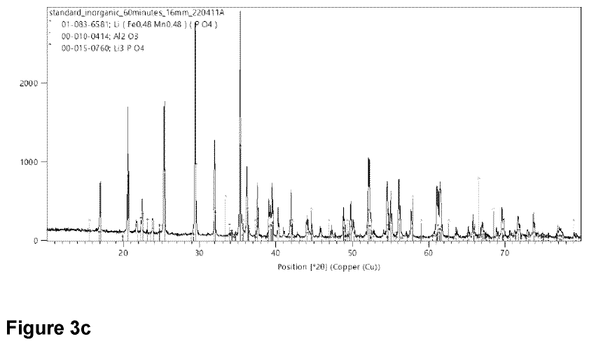

For this example, four syntheses have been conducted to obtain the LiFe_{0.5}Mn_{0.5}PO₄ composition under different atmospheres and from different reactants. In Example 3a, the reactants used are LiPO₃+MnCO₃+FeC₂O₄ that are heated, melted and held at 1100° C. in an open graphite crucible under non-buffered N₂ atmosphere for one hour followed by cooling under N₂. As shown on FIG. 3a, the XRD confirms the composition with no impurity or traces of oxidation.

Example 3b is similar to Example 3a but using different reactants: LiPO₃+MnO₂+Fe⁰. The feed molar ratios are such that the reduction of the Mn⁴⁺ is balanced by the presence of Fe⁰ without need for additional reducing agent such as carbon resulting in an oxidation state of +2 for both Mn and Fe. The synthesis conditions are otherwise similar to those of Example 3a. The XRD obtained, shown in FIG. 3b, confirms the expected LiFe_{0.5}Mn_{0.5}PO₄ structure and composition without any secondary phase or oxidized compound.

Example 3c is the same as Example 3b, except for the use of an alumina crucible to avoid any possible contribution of the graphite to a local reducing atmosphere. The XRD obtained, shown in FIG. 3c, confirms the expected LiFe_{0.5}Mn_{0.5}PO₄ olivine structure and composition without any detectable oxidized compound, but with the presence of traces of Al related impurity and Li₃PO₄ that can be explained by partial dissolution of alumina through reaction with the melt.

Examples 3a-c show that Mn-rich olivine can be made under a non-reducing and non-buffered atmosphere such as N₂ or Argon (pO₂ variable but approximately 10−⁵-10⁻⁴ atm.) and that if any oxidation occurs, it remains below XRD analysis precision. Furthermore, it is important to keep in mind, as will be shown in the following examples that slight accidental degree of LiFe_{0.5}Mn_{0.5}PO₄ oxidation during the melt could easily be corrected after comminution by reducing gas hot treatment, such as 5% H₂ in N₂ at 800° C. to avoid powder sintering or alternatively during the powder carbon coating resulting from an organic carbon precursor pyrolysis at higher temperature, e.g., 650-850° C.

Example 3d is similar to Example 3c but using air (pO₂=0.2 atm) instead of non-buffered N₂. The test uses an alumina crucible kept in air during the synthesis but cast and cooled under nitrogen. In this case, the XRD reveals an olivine structure along with an AlPO₄ phase in small amount, but also with a few % Fe₂O₃ and corresponding Li₃Fe₂(PO₄)₃ visible. Although this product is not at that point useful as a cathode material, treatment of half of the ground sample with a 5% H₂/N₂ at 650° C. for half an hour presents an XRD pattern typical of the LiFe_{0.5}Mn_{0.5}PO₄ composition. When the rest of this ground sample is carbon-coated at 700° C. under a N₂ flow using 6% lactose as carbon precursor dispersed in isopropyl alcohol, the XRD does not show the Fe³⁺ oxidation impurities anymore. When a cell with a lithium anode is made with this carbon-coated powder, a discharge capacity of 145 mAh/g is obtained at a rate of C/10 confirming that the powder characteristics as defined from the melt composition are reversed and preserved or reversed by the process of the invention despite a partial oxidation of the Fe—Mn composition during the melt synthesis under air.

Although neither this cathode composition nor the synthesis conditions were optimized for energy content, these results confirm that Mn-rich LiFe_{0.5}Mn_{0.5}PO₄ compositions can be made in non-reductive, non-buffered N₂- or Ar-based atmosphere including air.

### Example 4: Mn-Rich LiFe_{0.25}Mn_{0.75}PO₄ Composition Synthesis Under Air and Under an Inert, Non-Buffered Atmosphere

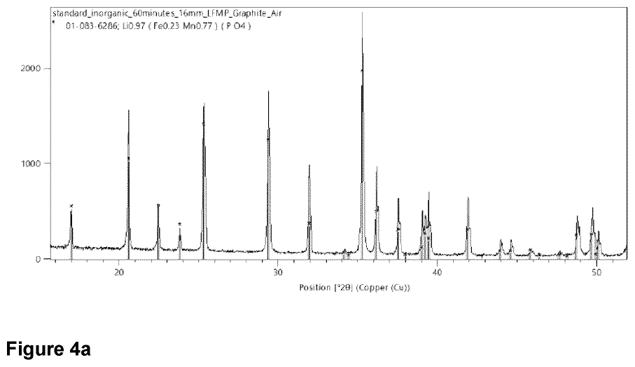

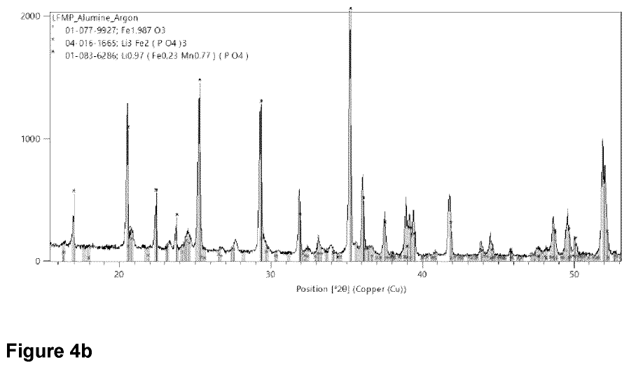

In Example 4a a mixture of LiPO₃+MnCO₃+FeC₂O₄ precursors is heated at 1100° C. for one hour under air in a graphite crucible followed by cooling under air atmosphere. XRD analysis shown in FIG. 4a confirms an olivine phase with no visible impurity. A partially reducing atmosphere linked to the graphite crucible might explain this result along with a slower kinetic of oxidation of this Mn-rich melt.

Example 4b is similar to Example 4a, except for the graphite crucible which is replaced by an alumina one and the cooling performed under Ar. XRD analysis shows the olivine structure, but also a partial oxidation of iron by air since no local reducing atmosphere is present.

In Example 4c the mixture of LiPO₃+MnCO₃+FeC₂O₄ precursors is heated at 1100° C. for one hour under N₂ atmosphere in an alumina crucible followed by cooling under an Ar atmosphere. In this case, the non-buffered N₂ atmosphere (pO₂~10⁻⁵-10⁻⁴) avoids or limits the iron oxidation since only the olivine composition is observed along with traces of Li₃PO₄ and small AlPO₄ contamination from the crucible, similar to what was observed in FIG. 3c as to the presence of small amount of AlPO₄ and Li₃PO₄. This test shows that Mn-rich LFMP olivine can be made under non-buffered N₂ atmosphere without any or no significant Fe⁺³ formation probably due to reduced Fe activity in the melt. In cases where accidental Fe⁺³ is formed, it could be eliminated by a post-comminution reduction by the gas during a thermal treatment as shown in the following example.

### Example 5: Correction of a Partially Oxidized LiFe_{0.25}Mn_{0.75}PO₄ Composition

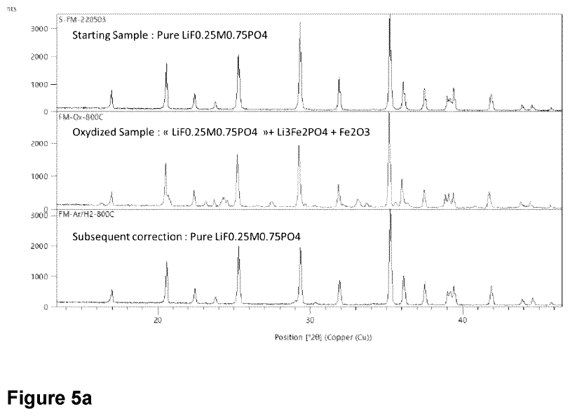

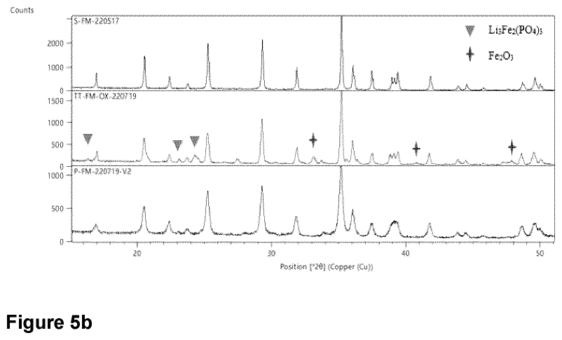

In this example, an Mn-rich LiFe_{0.25}Mn_{0.75}PO₄ composition is made as in Example 4a and subjected to comminution in a wet mill to obtain a sub-micron pure olivine powder as confirmed by RDX, upper part of FIG. 5a. This powder is then exposed to air at 800° C. for half an hour. The XRD in the center of FIG. 5a shows the result of the oxidation of the powder compositions in which most of the iron is oxidized to Fe₂O₃ and Li₃Fe₂(PO₄)₃ along with an Mn-rich olivine structure whose crystal lattice parameter confirms Mn enrichment of the olivine structure. What is interesting to note is that this oxidized powder can be reverted back to the original LiFe_{0.25}Mn_{0.75}PO₄ composition by a reducing H₂/Ar gas treatment at 800° C. as shown by the XRD analysis in the lower part of FIG. 5a. This example confirms what was observed in Example 3c and the possibility to melt synthesized LiFe₁₋ₓMnₓPO₄ in which x varies between 0 and 1 under non-reducing atmosphere or non-buffered N₂, Ar, CO₂ mixtures. This is possible because of the greater LiMnPO₄ stability under air, but also because any iron oxidation to Fe⁺³ is reversible by a simple reduction gas thermal treatment on the solidified powder after comminution. Alternatively, such iron oxidation can be corrected during the pyrolysis of an organic carbon precursor in N₂ at 700° C. to carbon-coat the olivine powder to make it electrochemically active. Although not optimized in this example one can observe the reductive correction in FIG. 5b, lower result, with some Fe⁺³ still present.

### Example 6: Correction of a Partially Oxidized LiFe_{0.25}Mn_{0.75}PO₄ Composition

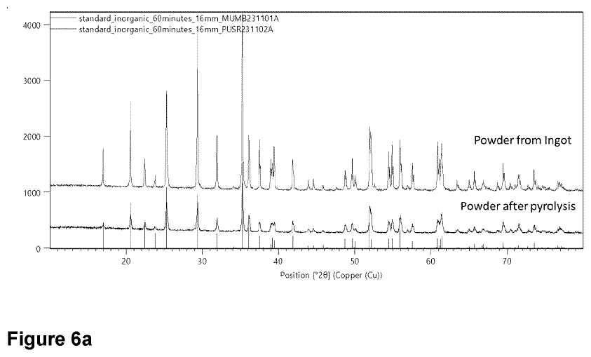

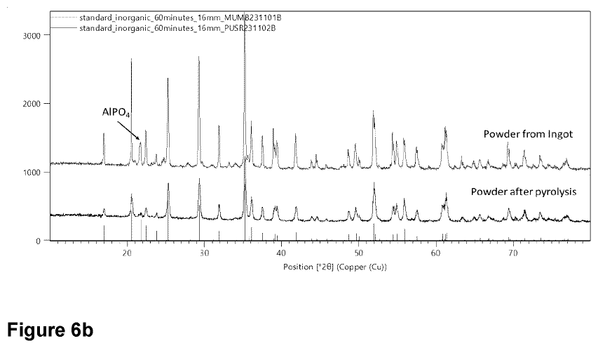

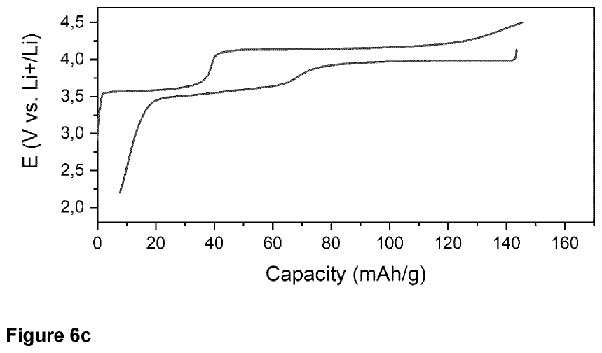

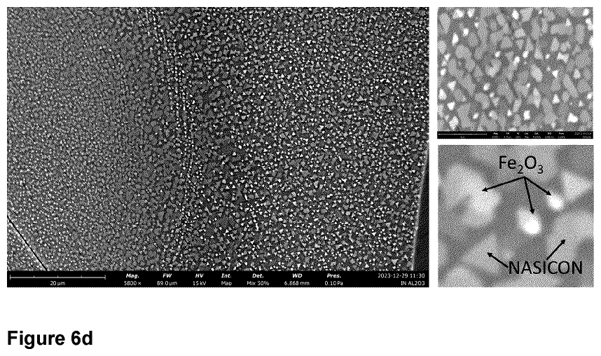

In this Example 6a, an Mn-rich LiFe_{0.25}Mn_{0.75}PO₄ composition is made using LiPO₃+MnCO₃+Fe₂O₃+Fe⁰. The reactants are melted and held at 1100° C. in an open graphite crucible. After one hour at 1100° C., the molten media is cast and cooled slowly in a graphite mold. The resulting ingot is subsequently ground to powder below 75 μm in order to obtain the XRD shown in FIG. 6a, upper part, a pure microstructure is obtained with no visible Fe⁺³ oxidation impurity due to slow kinetic and/or the possible reducing environment of graphite.

When the olivine powder obtained is further wet milled to D50 of 200 nm in the presence of a lactose carbon precursor in order to obtain C—LiFe_{0.25}Mn_{0.75}PO₄ with ca. 2% of carbon after pyrolysis at 650° C., a black powder is obtained. The XRD pattern shown in FIG. 6a, lower part, also presents a pure microstructure.

In this Example 6b, the same Mn-rich LiFe_{0.25}Mn_{0.75}PO₄ composition is made using LiPO₃+MnCO₃+Fe₂O₃+Fe. The reactants are melted and held at 1100° C. in an open alumina crucible under air. After one hour at 1100° C., the molten media is cast, one part being cooled slowly in a mold to obtain an ingot and the second part being casted and cooled very rapidly onto a steel plate cooled in liquid nitrogen.

The two samples are subsequently ground to powder below 75 μm in order to obtain their XRD. It is interesting to note that the part very rapidly cooled is easier to grind. The result for the slow cooled ingot is shown on FIG. 6b, upper part, where part of the iron is oxidized to Fe₂O₃ and Li₃Fe₂(PO₄)₃ along with an Mn-enriched olivine structure as confirmed by the crystal lattice parameter shift to Mn-richer value, from 299.5 Å³ to 301.0 Å³. The presence of AlPO₄ from crucible contamination is also visible.

When the olivine powder obtained is further wet-milled to D50 of 200 nm in the presence of a lactose carbon precursor in order to get C—LiFe_{0.25}Mn_{0.75}PO₄ with ca. 2% of carbon after pyrolysis at 650° C., a black powder is obtained. The XRD pattern shown in FIG. 6b, lower part. Interestingly, this oxidized powder is reverted back to the targeted LiFe_{0.25}Mn_{0.75}PO₄ composition by the reducing atmosphere during the pyrolysis. Consequently, the material delivers a reversible capacity of close to 145 mAh/g as shown in FIG. 6c.

As shown in FIG. 6d, rapid cooling of material from Example 6b provides more information on oxidized melt solidification. SEM observation from the cooled surface shows that phase separation quickly occurs during solidification and leads to the formation of 1-2 μm size crystals of Li₃Fe₂(PO₄)₃ and Fe₂O₃ homogeneously dispersed in a matrix of Mn-enriched LiFe_{0.25}Mn_{0.75}PO₄ according to EDX analysis and further confirmed by XRD. Crystals size and dispersion are influenced by the cooling rate of the molten material, and this can advantageously be used for the comminution to sub-micron powders.

This example further confirms the observations made on the examples presented herein above and the possibility to melt synthesized LiFe₁₋ₓMnₓPO₄ in which x varies between 0 and 1 under non-reducing atmosphere or non-buffered N₂, Ar, CO₂ mixtures. This is possible because of the greater LiMnPO₄ thermodynamic and/or kinetic stability under air as opposed to LiFePO₄, but also because any possible slight iron oxidation to Fe⁺³ in the melt is shown to be reversible during a thermal treatment step in a reducing atmosphere made on oxidized powder after comminution.

As will be understood by a skilled person, other variations and combinations may be made to the various embodiments of the invention as described herein above.

While the present disclosure has been described in connection with specific embodiments thereof, it will be understood that it is capable of further modifications and this application is intended to cover any variations, uses, or adaptations including such departures from the present disclosure as come within known or customary practice within the art and as may be applied to the essential features hereinbefore set forth, and as follows in the scope of the appended claims. Features which are described in the context of separate aspects and embodiments of the invention may be used together and/or be interchangeable. Similarly, features described in the context of a single embodiment may also be provided separately or in any suitable sub-combination.

The present description refers to a number of documents, the content of which is herein incorporated by reference in their entirety.

The scope of the claims should not be limited by the preferred embodiments set forth herein above; but should be given the broadest interpretation consistent with the description as a whole.

1. (canceled)

2. (canceled)

3. (canceled)

4. A melt process for preparing a cathode material of general formula LiFe₁₋ₓMnₓPO₄ in which x varies between 0 and 1, the process comprising at least one correction step for removing any oxidized iron impurities formed;
preferably the at least one correction step comprises reducing back any oxidized Fe⁺³ formed.

5. The melt process according to claim 1, wherein at least one correction step is conducted for removing any oxidized iron impurities formed;
preferably the at least one correction step comprises reducing back any oxidized Fe⁺³ formed.

6. The melt process according to claim 4, wherein the oxidized Fe⁺³ comprises Fe₂O₃ and/or Li₃Fe₂(PO₄)₃.

7. The melt process according to claim 4, further comprising melt casting, solidification, and comminution steps, and the at least one correction step is conducted after one or more of the melt casting, solidification, and comminution steps;
preferably the at least one correction step is conducted after the melt casting, solidification, and comminution steps.

8. The process according to claim 4, wherein an intermediate composition is produced:
optionally the intermediate composition is an Mn-enriched composition.

9. (canceled)

10. The process according to claim 4, wherein a reducing gas is used in the at least one correction step;
preferably the reducing gas is nitrogen containing only small amounts of H₂ and/or CO.

11. A melt process for preparing a cathode material of general formula LiFe₁₋ₓMnₓPO₄ in which x varies between 0 and 1, the process comprising the steps of:
a) melting together, in a reaction bath, reactants comprising a source of lithium, a source of iron, optionally a source of manganese, and at least one source of phosphate, individually or in combinations thereof, in desired stoichiometric proportions, and wherein the source of iron and the source of manganese are each at the +2 oxidation state or an equivalent mixture of metallic and +2 and +3 oxidation states, and wherein the reaction bath is held at a temperature between about 800 and about 1300° C., and wherein the melting is conducted under a non-buffered and non-reducing atmosphere which comprises air, N₂, Ar, CO₂, or a mixture thereof, thereby obtaining a liquid composition;
b) heating the liquid composition, followed by casting, cooling, and solidification, thereby obtaining a solid composition;
c) comminuting the solid composition, thereby obtaining a powder having micronized particles; and
d) subjecting the powder to a thermal reduction with a reducing gas atmosphere comprising H₂ and/or CO at a temperature between about 400° C. and about 900° C., thereby reducing any oxidized iron impurities formed.

12. The process according to claim 11, further comprising a step e) of coating a surface of the micronized particles with at least one adherent electric conductor;
preferably the adherent electric conductor comprises carbon.

13. The process according to claim 12, wherein the thermal reduction step d) and the coating step e) are conducted simultaneously by pyrolyzing an organic carbon precursor in the presence of the micronized particles to form a conductive carbon-coated cathode material (C—LiFe₁₋ₓMnₓPO₄).

14. The process according to claim 4, wherein LiFe₁₋ₓMnₓPO₄ in which x>0.7 is obtained.

15. The process according to claim 11, in which the sources of lithium and phosphate are each in stoichiometric excess by less than 5% molar.

16. The process according to claim 11, wherein the casting, cooling, and solidification at step b) is conducted fast enough to limit crystal growth to less than 10 μm; preferably less than 3 μm.

17. The process according to claim 11, wherein the casting, cooling, and solidification at step b) is conducted rapidly by melt atomization using a jet of a fluid that is N₂ or water, or by casting techniques used to form amorphous metal.

18. The process according to claim 11, wherein the particles obtained at the comminution step c) have a D50 between about 200 and about 10 nanometers as obtained by wet milling, the particles being present as secondary agglomerates whose D50 is less than 30 μm and more than 1 μm.

19. The process according to claim 12, wherein the carbon-coated cathode material contains an amount of carbon between about 0.5 and about 5 wt %;
preferably the carbon-coated cathode material contains an amount of carbon between about 0.8 and about 2 wt %.

20. The process according to claim 12, wherein the comminution of step c) is conducted in wet mill using a solvent;
preferably the solvent comprises a soluble iron salt that remains at the surface of the particles during the organic carbon precursor pyrolysis.

21. Cathode material made by the process as defined in claim 4;
preferably the cathode material is a lithium iron phosphate (LFP), a lithium iron manganese phosphate (LFMP), or a lithium manganese phosphate (LMP) cathode material;
preferably the cathode material is carbon-coated.

22. Cathode material made by the process as defined in claim 12, having and iron-rich surface on which the conductive carbon-coating is grown.

23. Battery having a cathode comprising a material made by the process as defined in claim 4.

24. Cathode or battery manufacturing plant which embodies the process as defined in claim 4.
